(19) United States
(12) Patent Application Publication
(10) Pub. No.: US 2022/0246918 A1
(43) Pub. Date: Aug. 4, 2022

(54) COATED GRAPHITE TYPE NEGATIVE ELECTRODE ACTIVE MATERIAL

(71) Applicant: Prime Planet Energy & Solutions, Inc., Tokyo (JP)

(72) Inventor: Shinsuke MATSUHARA, Miyoshi-shi (JP)

(21) Appl. No.: 17/585,571

(22) Filed: Jan. 27, 2022

(30) Foreign Application Priority Data
Feb. 1, 2021 (JP) 2021-014356

(51) Int. Cl. H01M 4/36; H01M 4/587; H01M 10/0525

(52) U.S. Cl. CPC H01M 4/366; H01M 2004/027; H01M 10/0525; H01M 4/587

(57) ABSTRACT

A coated graphite type negative electrode active material is provided which can reduce the low temperature resistance of a secondary battery. The coated graphite type negative electrode active material herein disclosed includes graphite, an amorphous carbon layer coating the graphite, and an intermediate layer situated between the graphite and the amorphous carbon layer. The intermediate layer is a carbon layer doped with boron. The amorphous carbon layer substantially does not include boron.

### BACKGROUND OF THE INVENTION

### 1. Field of the Invention

The present disclosure relates to a graphite type negative electrode active material coated with amorphous carbon. The present application claims the priority based on Japanese Patent Application No. 2021-014356 filed on Feb. 1, 2021, the entire content of which is incorporated by reference in the present specification.

### 2. Description of the Related Art

In recent years, a secondary battery such as a lithium ion secondary battery has been suitably used as a portable power supply for a personal computer, a portable terminal, or the like; a power supply for driving a vehicle such as a battery electric vehicle (BEV), a hybrid electric vehicle (HEV), or a plug-in hybrid electric vehicle (PHEV); or the like.

Generally, for a negative electrode of a secondary battery, particularly, of a lithium ion secondary battery, a graphite type negative electrode active material is used. With more and more secondary batteries being used, performance thereof is demanded to be further enhanced. One of the measures for enhancing the performances may be improvement of the graphite type negative electrode active material. As an example of the improvement of the graphite type negative electrode active material, a negative electrode active material of a multiple-layered structure is known in which the surface of graphite is coated with amorphous carbon (see, e.g., Japanese Patent Application Publication No. 2012-74297).

### SUMMARY OF THE INVENTION

However, according to the diligent study of the present inventor, it has been found that, with the conventional art, the secondary battery using graphite type negative electrode active material having a coating (i.e., a coated graphite type negative electrode active material) is undesirably insufficient in reduction of the resistance at low temperatures.

In view of the foregoing circumstances, it is an object of the present disclosure to provide a coated graphite type negative electrode active material capable of reducing the low temperature resistance of a secondary battery.

The coated graphite type negative electrode active material herein disclosed includes: graphite; an amorphous carbon layer coating the graphite; and an intermediate layer situated between the graphite and the amorphous carbon layer. The intermediate layer is a carbon layer doped with boron. The amorphous carbon layer substantially does not include boron. With such a configuration, it is possible to provide a coated graphite type negative electrode active material capable of reducing the low temperature resistance of a secondary battery.

In accordance with one desirable aspect of the coated graphite type negative electrode active material herein disclosed, a dope amount of boron in the intermediate layer is 0.1 atom % or more and 5.5 atom % or less. With such a configuration, it is possible to particularly reduce the low temperature resistance of a secondary battery.

The coated graphite type negative electrode active material herein disclosed can be desirably manufactured by a manufacturing method including the steps of: forming a first coating layer including carbon and boron on graphite by a chemical vapor deposition method using a gas including a carbon precursor and a boron precursor; and forming a second coating layer including carbon on the first coating layer by a chemical vapor deposition method using a gas not including a boron precursor and including a carbon precursor.

From another aspect, the secondary battery herein disclosed includes a positive electrode, a negative electrode, and an electrolyte. The negative electrode includes the graphite type negative electrode active material. With such a configuration, it is possible to provide a secondary battery having a small low temperature resistance.

### BRIEF DESCRIPTION OF THE DRAWINGS

FIG. 1 is a schematic cross sectional view of one example of a coated graphite type negative electrode active material in accordance with one embodiment of the present disclosure;

FIG. 2 is a cross sectional view schematically showing a configuration of a lithium ion secondary battery constructed using a coated graphite type negative electrode active material in accordance with one embodiment of the present disclosure; and

FIG. 3 is a schematic exploded view showing a configuration of a wound electrode body of the lithium ion secondary battery of FIG. 2.

### DESCRIPTION OF THE PREFERRED EMBODIMENTS

Hereinafter, referring to the accompanying drawings, embodiments in accordance with the present disclosure will be described. It should be noted that matters necessary for executing the present disclosure, except for matters specifically referred to in the present specification can be grasped as design matters of those skilled in the art based on the related art in the present field. The present disclosure can be executed based on the contents disclosed in the present specification, and the technical common sense in the present field. Further, in the following drawings, the members/parts producing the same action are given the same numeral and sign for description. Further, the dimensional relationships (such as the length, width, and thickness) in each drawing do not reflect the actual dimensional relationships.

It should be noted that in the present specification, the term “secondary battery” is a term denoting an electric storage device capable of repeatedly charging and discharging, and including a so-called storage battery and an electric storage element such as an electric double layer capacitor. Further, in the present specification, the term “lithium ion secondary battery” represents a secondary battery using lithium ions as electric charge carriers, and implementing charging and discharging by transfer of electric charges accompanying lithium ions between the positive and negative electrodes.

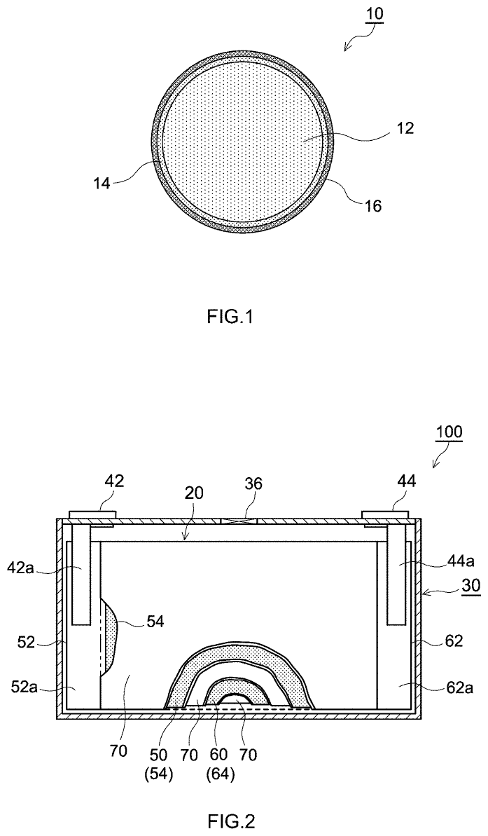

A coated graphite type negative electrode active material in accordance with the present embodiment includes graphite, an amorphous carbon layer which coats the graphite, and an intermediate layer situated between the graphite and the amorphous carbon layer. Herein, the intermediate layer is a carbon layer doped with boron. The amorphous carbon layer substantially does not include boron. FIG. 1 schematically shows a cross section of one example of the coated graphite type negative electrode active material in accordance with the present embodiment. It should be noted that the coated graphite type negative electrode active material in accordance with the present embodiment is not limited to that shown in FIG. 1.

As shown in FIG. 1, a coated graphite type negative electrode active material 10 in accordance with the present embodiment includes graphite 12 as a core part, and has an intermediate layer 14 and an amorphous carbon layer 16 as coating layers. The intermediate layer 14 is situated between the graphite 12 and the amorphous carbon layer 16. The coated graphite type negative electrode active material 10 typically has only the intermediate layer 14 and the amorphous carbon layer 16 as coating layers. However, the coated graphite type negative electrode active material 10 may further have another layer within the range not to remarkably impair the effects of the present disclosure.

The graphite 12 may be natural graphite or artificial graphite. The shape of the graphite 12 has no particular restriction, and may be a scaly, spherical, or amorphous shape, or other shapes. Since it is easy to provide the intermediate layer 14 and the amorphous carbon layer 16 having an uniform thickness, the graphite 12 is desirably spherical.

The intermediate layer 14 is a carbon layer, and the intermediate layer 14 is doped with boron (B). Namely, the intermediate layer 14 includes boron. The dope amount (i.e., the content) of boron has no particular restriction so long as the effects of the present disclosure can be obtained. When the dope amount is too small, the low temperature resistance reducing effect due to boron doping tends to be reduced. Accordingly, the dope amount of boron at the intermediate layer 14 is desirably 0.1 atom % or more, more desirably 0.3 atom % or more, and further desirably 0.5 atom % or more. On the other hand, even when the dope amount is too large, the low temperature reducing effect tends to be reduced. Accordingly, the dope amount of boron at the intermediate layer 14 is desirably 5.5 atom % or less, more desirably 4.6 atom % or less, and further desirably 4.0 atom % or less.

It should be noted that the dope amount of boron at the intermediate layer 14 can be determined by performing depth direction analysis (depth analysis) using Ar monomer ions by means of an X-ray photoelectron spectroscopy (XPS) device.

The thickness of the intermediate layer 14 has no particular restriction. The thickness of the intermediate layer 14 is, for example, 3 nm or more and 50 nm or less, desirably 10 nm or more and 40 nm or less, and more desirably 15 nm or more and 30 nm or less. Further, the thickness of the intermediate layer 14 is desirably smaller than the thickness of the amorphous carbon layer 16. It should be noted that the thickness of the intermediate layer 14 can be determined by observing the cross section of the coated graphite type negative electrode active material 10 using a transmission electron microscope (TEM).

As with the example shown, the intermediate layer 14 typically coats the entire surface of the graphite 12. However, the intermediate layer 14 may partially coat the graphite 12 unless the effects of the present disclosure are remarkably impaired.

On the other hand, although the amorphous carbon layer 16 is also a carbon layer, the amorphous carbon layer 16 substantially does not include boron. In the present specification, the wording “layer substantially does not include boron” means that although boron is not positively added, boron may be included as an impurity, and specifically represents that the content of boron in the layer is less than 0.005 atom %. The boron content in the amorphous carbon layer 16 is desirably less than 0.001 atom %, and more desirably 0 atom %. Namely, more desirably, the amorphous carbon layer 16 does not include boron. The boron content in the amorphous carbon layer 16 can be determined in the same manner as with the dope amount of boron in the intermediate layer 14.

The thickness of the amorphous carbon layer 16 has no particular restriction. The thickness of the amorphous carbon layer 16 is, for example, 10 nm or more and 500 nm or less, desirably 30 nm or more and 400 nm or less, and more desirably 30 nm or more and 300 nm or less. It should be noted that the thickness of the amorphous carbon layer 16 can be determined by observing the cross section of the coated graphite type negative electrode active material 10 using a transmission electron microscope (TEM).

As with the example shown, the amorphous carbon layer 16 typically coats the entire surface of the intermediate layer 14. However, the amorphous carbon layer 16 may partially coat the intermediate layer 14 unless the effects of the present disclosure are remarkably impaired.

Although the average particle diameter (median diameter: D50) of the coated graphite type negative electrode active material 10 has no particular restriction, the average particle diameter (median diameter: D50) is, for example, 0.1 μm or more and 50 μm or less, desirably 1 μm or more and 25 μm or less, and more desirably 5 μm or more and 20 μm or less. It should be noted that the average particle diameter (D50) represents the particle diameter at which the cumulative frequency from the smaller particle diameter side is 50% by volume in the particle size distribution measured by a laser diffraction scattering method.

For a conventional coated graphite type negative electrode active material, the difference in crystallinity between graphite and coating of amorphous carbon is too large. For this reason, the diffusibility of lithium ions at the interface therebetween is inferior. As a result, the low temperature resistance is degraded.

However, for the coated graphite type negative electrode active material 10 in accordance with the present embodiment, a carbon layer doped with boron (i.e., the intermediate layer 14) is provided between the graphite 12 and the coating of amorphous carbon (i.e., the amorphous carbon layer 16). The intermediate layer 14 serves as a buffer layer against the difference in the crystallinity. The intermediate layer 14 can improve the diffusibility of lithium ions between the amorphous carbon layer 16 and the graphite 12. As a result, the low temperature resistance can be improved. Namely, it is possible to reduce the low temperature resistance of the secondary battery using the coated graphite type negative electrode active material 10.

The coated graphite type negative electrode active material in accordance with the present embodiment can be desirably manufactured in the following manner. It should be noted that the coated graphite type negative electrode active material in accordance with the present embodiment is not limited to those manufactured by the following manufacturing method.

A desirable manufacturing method of the coated graphite type negative electrode active material in accordance with the present embodiment includes a step (first coating step) of forming a first coating layer including carbon and boron on graphite by a chemical vapor deposition (CVD) method using a gas including a carbon precursor and a boron precursor, and a step (second coating step) of forming a second coating layer including carbon on the first coating layer by the chemical vapor deposition method using a gas not including a boron precursor and including a carbon precursor.

As the carbon precursor for use in the first coating step, a known carbon precursor for use in the CVD method may be used. Specific examples thereof may include hydrocarbon compounds such as methane, ethane, propane, ethylene, acetylene, benzene, and toluene. Out of these, methane is desirable.

As the boron precursor for use in the first coating step, a known boron precursor for use in the CVD method may be used. Specific examples thereof may include boron trichloride and diborane. Out of these, boron trichloride is desirable.

In the first coating step, the chemical vapor deposition (CVD) can be performed using a known CVD device according to a known method. Graphite is in a particle shape. Accordingly, in order to uniformly form a coating layer on the surface of a graphite particle, a rotary CVD device is desirably used. By carrying out the first coating step, it is possible to form the first coating layer (i.e., the intermediate layer 14) including carbon and boron on the graphite 12.

Examples of the carbon precursor for use in the second coating step are the same as those of the carbon precursor for use in the first coating step. The carbon precursor for use in the first coating step and the carbon precursor for use in the second coating step may be the same as or different from each other, and preferably is the same as each other.

In the second coating step, the chemical vapor deposition (CVD) can be performed according to a known method. For example, the CVD can be performed by switching the gas including the precursor (e.g., stopping the supply of the boron precursor gas), and adopting known conditions, after carrying out the first coating step using a CVD device. By carrying out the second coating step, it is possible to form a second coating layer including carbon (i.e., the amorphous carbon layer 16) on the first coating layer (i.e., the intermediate layer 14).

Using the coated graphite type negative electrode active material 10 in accordance with the present embodiment, a secondary battery can be constructed according to a known method. Specifically, the coated graphite type negative electrode active material in accordance with the present embodiment is used for the negative electrode active material in a known secondary battery using a graphite type negative electrode active material. As a result, it is possible to construct a secondary battery.

By using the coated graphite type negative electrode active material in accordance with the present embodiment for a secondary battery, it is possible to reduce the low temperature resistance of the secondary battery. The coated graphite type negative electrode active material in accordance with the present embodiment is typically a coated graphite type negative electrode active material for a secondary battery, and is desirably a coated graphite type negative electrode active material for a lithium ion secondary battery. The secondary battery may be a nonaqueous electrolyte secondary battery including a nonaqueous electrolyte, or may be an all-solid-state secondary battery including a solid-state electrolyte.

Under such circumstances, from another aspect, the secondary battery in accordance with the present embodiment includes a positive electrode, a negative electrode, and an electrolyte, and the negative electrode includes the above-described coated graphite type negative electrode active material.

Below, the secondary battery in accordance with the present embodiment will be described in details by taking a flat square lithium ion secondary battery having a flat-shaped wound electrode body and a flat-shaped battery case as an example. However, the secondary battery in accordance with the present embodiment is not limited to the examples described below.

The lithium ion secondary battery 100 shown in FIG. 2 is a sealed-type battery constructed by accommodating a flat-shaped wound electrode body 20 and a nonaqueous electrolyte (not shown) in a flat square battery case (i.e., an exterior container) 30. The battery case 30 is provided with a positive electrode terminal 42 and a negative electrode terminal 44 for external connection, and a thin-walled safety valve 36 set so as to release the internal pressure when the internal pressure of the battery case 30 increases to a prescribed level, or higher. The positive and negative electrode terminals 42 and 44 are electrically connected with the positive and negative electrode current collector plates 42a and 44a, respectively. For the material for the battery case 30, for example, a metal material which is lightweight and has good heat conductivity such as aluminum is used.

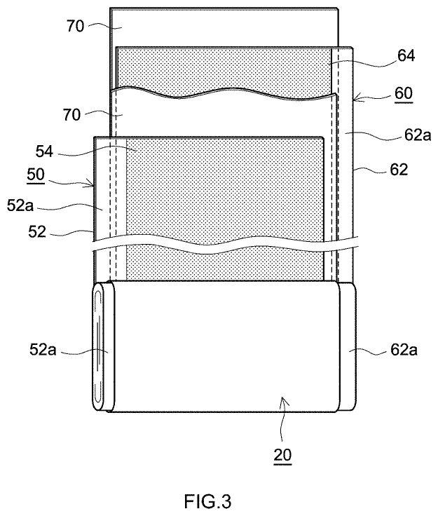

The wound electrode body 20 has a form in which the positive electrode sheet 50 and the negative electrode sheet 60 are stacked one on another via two long separator sheets 70, and are wound as shown in FIG. 2 and FIG. 3. The positive electrode sheet 50 has a configuration in which a positive electrode active material layer 54 is formed along the longitudinal direction on one surface or both surfaces (herein, both surfaces) of a long positive electrode current collector 52. The negative electrode sheet 60 has a configuration in which a negative electrode active material layer 64 is formed along the longitudinal direction on one surface or both surfaces (herein, both surfaces) of a long negative electrode current collector 62. A positive electrode active material layer non-formation part 52a (i.e., the part at which the positive electrode active material layer 54 is not formed, and the positive electrode current collector 52 is exposed) and a negative electrode active material layer non-formation part 62a (i.e., the part at which the negative electrode active material layer 64 is not formed, and the negative electrode current collector 62 is exposed) are formed so as to protrude from the opposite ends in the winding axis direction of the wound electrode body 20 (i.e., the sheet width direction orthogonal to the longitudinal direction) to the outside, respectively. The positive electrode active material layer non-formation part 52a and the negative electrode active material layer non-formation part 62a are joined with the positive electrode current collector plate 42a and the negative electrode current collector plate 44a, respectively.

As the positive electrode current collector 52, a known positive electrode current collector for use in a lithium ion secondary battery may be used. Examples thereof may include a sheet or foil made of a metal having good electric conductivity (e.g., aluminum, nickel, titanium, or stainless steel). As the positive electrode current collector 52, aluminum foil is desirable.

The dimensions of the positive electrode current collector 52 have no particular restriction, and may be appropriately determined according to the battery design. When aluminum foil is used as the positive electrode current collector 52, the thickness thereof has no particular restriction, and is, for example, 5 μm or more and 35 μm or less, and desirably 7 μm or more and 20 μm or less.

The positive electrode active material layer 54 includes a positive electrode active material. Examples of the positive electrode active material may include lithium transition metal composite oxides such as a lithium nickel type composite oxide (such as LiNiO₂), a lithium cobalt type composite oxide (such as LiCoO₂), a lithium nickel cobalt manganese type composite oxide (such as LiNi_{1/3}Co_{1/3}Mn_{1/3}O₂), a lithium nickel cobalt aluminum type composite oxide (such as LiNi_{0.8}Co_{0.15}Al_{0.5}O₂), a lithium manganese type composite oxide (such as LiMn₂O₄), and a lithium nickel manganese type composite oxide (such as LiNi_{0.5}Mn_{1.5}O₄); and lithium transition metal phosphate compound (such as LiFePO₄).

The positive electrode active material layer 54 may include other components than the positive electrode active material, for example, trilithium phosphate, a conductive material, and a binder. As the conductive materials, for example, carbon black such as acetylene black (AB), or other carbon materials (such as graphite) can be desirably used. As the binder, for example, polyvinylidene fluoride (PVDF) can be used.

The content of the positive electrode active material in the positive electrode active material layer 54 (i.e., the content of the positive electrode active material based on the total mass of the positive electrode active material layer 54) has no particular restriction, and is desirably 70 mass % or more, more desirably 80 mass % or more and 97 mass % or less, and further desirably 85 mass % or more and 96 mass % or less. The content of trilithium phosphate in the positive electrode active material layer 54 has no particular restriction, and is desirably 1 mass % or more and 15 mass % or less, and more desirably 2 mass % or more and 12 mass % or less. The content of the conductive material in the positive electrode active material layer 54 has no particular restriction, and is desirably 1 mass % or more and 15 mass % or less, and more desirably 3 mass % or more and 13 mass % or less. The content of the binder in the positive electrode active material layer 54 has no particular restriction, and is desirably 1 mass % or more and 15 mass % or less, and more desirably 1.5 mass % or more and 10 mass % or less.

The thickness of the positive electrode active material layer 54 has no particular restriction, and is, for example, 10 μm or more and 300 μm or less, and desirably 20 μm or more and 200 μm or less.

As the negative electrode current collector 62, a known negative electrode current collector for use in a lithium ion secondary battery may be used. Examples thereof may include a sheet or foil made of a metal having good electric conductivity (e.g., copper, nickel, titanium, or stainless steel). As the negative electrode current collector 52, copper foil is desirable.

The dimensions of the negative electrode current collector 62 have no particular restriction, and may be appropriately determined according to the battery design. When copper foil is used as the negative electrode current collector 62, the thickness thereof has no particular restriction, and is, for example, 5 μm or more and 35 μm or less, and desirably 7 μm or more and 20 μm or less.

The negative electrode active material layer 64 includes the above-described coated graphite type negative electrode active material as a negative electrode active material. The negative electrode active material layer 64 may include other negative electrode active materials in addition to the coated graphite type negative electrode active material within the range not to remarkably impair the effects of the present disclosure.

The negative electrode active material layer 64 can include other components than the active material, for example, a binder and a thickener. As the binder, for example, styrene butadiene rubber (SBR), or polyvinylidene fluoride (PVDF) can be used. As the thickener, for example, carboxymethyl cellulose (CMC) can be used.

The content of the negative electrode active material in the negative electrode active material layer is desirably 90 mass % or more, and more desirably 95 mass % or more and 99 mass % or less. The content of the binder in the negative electrode active material layer is desirably 0.1 mass % or more and 8 mass % or less, and more desirably 0.5 mass % or more and 3 mass % or less. The content of the thickener in the negative electrode active material layer is desirably 0.3 mass % or more and 3 mass % or less, and more desirably 0.5 mass % or more and 2 mass % or less.

The thickness of the negative electrode active material layer 64 has no particular restriction, and is, for example, 10 μm or more and 300 μm or less, and desirably 20 μm or more and 200 μm or less.

Examples of the separator 70 may include a porous sheet (film) made of a resin such as polyethylene (PE), polypropylene (PP), polyester, cellulose, or polyamide. Such a porous sheet may be of a monolayered structure, or may be of a lamination structure of two or more layers (e.g., a three-layered structure in which PP layers are stacked on both surfaces of a PE layer). A heat resistant layer (HRL) may be provided on the surface of the separator 70.

The thickness of the separator 70 has no particular restriction, and is, for example, 5 μm or more and 50 μm or less, and desirably 10 μm or more and 30 μm or less.

The nonaqueous electrolyte typically includes a nonaqueous solvent and a support salt (electrolyte salt). As the nonaqueous solvents, various organic solvents such as carbonates, ethers, esters, nitriles, sulfones, and lactones for use in the electrolyte of a general lithium ion secondary battery can be used without particular restriction. Out of these, carbonates are desirable. Specific examples thereof may include ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), and trifluoro dimethyl carbonate (TFDMC). Such nonaqueous solvents can be used singly alone, or in appropriate combination of two or more thereof.

As the support salts, for example, lithium salts (desirably LiPF₆) such as LiPF₆, LiBF4, and lithium bis(fluorosulfonyl)imide (LiFSI) can be desirably used. The concentration of the support salt is desirably 0.7 mol/L or more and 1.3 mol/L or less.

It should be noted that the nonaqueous electrolyte may include other components than the foregoing components, various additives, for example, a film forming agent such as an oxalato complex; a gas generator such as biphenyl (BP) or cyclohexyl benzene (CHB); and thickener unless the effects of the present disclosure are remarkably impaired.

The lithium ion secondary battery 100 is usable for various uses. As desirable uses thereof, mention may be made of driving power supply to be mounted on vehicles such as a battery electric vehicle (BEV), a hybrid electric vehicle (HEV), and a plug-in hybrid electric vehicle (PHEV). Further, the lithium ion secondary battery 100 can be used as a storage battery of a compact electric power storage device, and the like. The lithium ion secondary battery 100 can also be typically used as a form of a battery pack including a plurality of batteries connected in series and/or in parallel with each other therein.

Up to this point, as an example, a square type lithium ion secondary battery including a flat-shaped wound electrode body has been described. However, the coated graphite type negative electrode active material in accordance with the present embodiment is also usable for other kinds of lithium ion secondary batteries according to a known method. For example, it is also possible to construct a lithium ion secondary battery including a stacked-type electrode body (i.e., an electrode body including a plurality of positive electrodes and a plurality of negative electrodes stacked one on another alternately) using the coated graphite type negative electrode active material in accordance with the present embodiment. Further, it is also possible to construct a cylindrical lithium ion secondary battery, a laminate-cased type lithium ion secondary battery, or the like using the coated graphite type negative electrode active material in accordance with the present embodiment. Further, it is also possible to construct other nonaqueous electrolyte secondary batteries than a lithium ion secondary battery according to a known method, using the coated graphite type negative electrode active material in accordance with the present embodiment.

Further, according to a known method, using a solid-state electrolyte (such as a sulfide solid-state electrolyte, or an oxide solid-state electrolyte) in place of a nonaqueous electrolyte, and interposing the solid-state electrolyte between the positive electrode and the negative electrode in place of the separator, it is also possible to construct an all-solid-state secondary battery (particularly, all-solid-state lithium ion secondary battery).

Below, examples in accordance with the present disclosure will be described in details. However, it is not intended that the present disclosure is limited to such examples.

### Manufacturing of Coated Graphite Type Negative Electrode Active Material

### Comparative Example 1

A spherical graphite having an average particle diameter (D50) of about 8 μm (SG-BH8: manufactured by Ito Graphite Co., Ltd.) was prepared. With a rotary CVD device including a tube furnace, using methane (CH₄) for a carbon precursor, 20 g of the graphite was subjected to chemical vapor deposition under the conditions of temperature of 950° C., an Ar introduction amount of 50 sccm, and a CH₄ introduction amount of 150 sccm for 60 minutes. This resulted in a coated graphite type negative electrode active material of Comparative Example 1.

### Comparative Example 2

In the same manner as in Comparative Example 1, 20 g of the graphite was subjected to chemical vapor deposition, thereby forming a coating layer. The resulting coated graphite type negative electrode active material was subsequently subjected to burning under an Ar atmosphere at 1500° C. for 6 hours. This resulted in a coated graphite type negative electrode active material of Comparative Example 2.

### EXAMPLE 1

A spherical graphite having an average particle diameter (D50) of about 8 μm (SG-BH8: manufactured by Ito Graphite Co., Ltd.) was prepared. With a rotary CVD device including a tube furnace, using methane (CH₄) for a carbon precursor, and using boron tetrachloride for a boron precursor, 20 g of the graphite was subjected to chemical vapor deposition (first chemical vapor deposition) at a temperature of 950° C. for 5 minutes. Subsequently, using only methane (CH₄) as a carbon precursor, the resulting graphite was subjected to chemical vapor deposition (second chemical vapor deposition) at a temperature of 950° C. for 40 minutes. This resulted in a coated graphite type negative electrode active material of Example 1.

### EXAMPLE 2

A coated graphite type negative electrode active material of Example 2 was obtained in the same manner as in Example 1 except for changing the time of the first chemical vapor deposition to 10 minutes, and changing the the time of the second chemical vapor deposition to 35 minutes.

### EXAMPLE 3

A coated graphite type negative electrode active material of Example 3 was obtained in the same manner as in Example 1 except for changing the time of the first chemical vapor deposition to 15 minutes, and changing the the time of the second chemical vapor deposition to 30 minutes.

Comparative Example 3

A spherical graphite having an average particle diameter (D50) of about 8 μm (SG-BH8: manufactured by Ito Graphite Co., Ltd.) was prepared. With a rotary CVD device including a tube furnace, using methane (CH₄) for a carbon precursor, and using boron tetrachloride for a boron precursor, 20 g of the graphite was subjected to chemical vapor deposition at a temperature of 950° C. for 45 minutes. This resulted in a coated graphite type negative electrode active material of Comparative Example 3.

### XPS Measurement of Coating Layer

For each coated graphite type negative electrode active material of respective Examples and respective Comparative Examples, the composition of the coating layer was analyzed using a XPS device. Specifically, the coated graphite type negative electrode active materials were subjected to measurement under the conditions of X-ray source: AlK α ray (monochromatic light), irradiation range: diameter (ϕ) 100 μm, and current/voltage: 25 kW 15 kV using a XPS device (“PHI 5000 VersaProbe 2” manufactured by ULVAC-PHI Co.). Then, using Ar monomer ions, depth direction analysis was performed under the conditions of voltage: 3 kV, current: 10 nA, area: 3 mm×3 mm, and rate: 3.05 nm/min. At this step, the composition analysis was performed for the lowest part of the coating layer. Specifically, when coating includes boron, the detection value at the depth immediately before boron is undetected with respect to the interface between graphite to be a core part and the coating layer was adopted. The composition analysis results are shown in Table 1.

### Manufacturing of Evaluating Lithium Ion Secondary Battery

LiNi_{1/3}Co_{1/3}Mn_{1/3}O₂ (LNCM) as a positive electrode active material powder, acetylene black (AB) as a conductive material, and polyvinylidene fluoride (PVDF) as a binder were mixed with N-methyl pyrrolidone (NMP) at mass ratios of LNCM:AB:PVDF=92:5:3, thereby preparing a positive electrode active material layer forming slurry. The slurry was applied on the surface of aluminum foil with a thickness of 15 μm, and was dried, followed by roll pressing, thereby manufacturing a positive electrode sheet.

Each graphite type negative electrode active material (C) of respective Examples and respective Comparative Examples, styrene butadiene rubber (SBR) as a binder, and carboxymethyl cellulose (CMC) as a thickener were mixed at mass ratios of C:SBR:CMC=99:0.5:0.5 in ion exchanged water, thereby preparing a negative electrode active material layer forming slurry. The slurry was applied on the surface of copper foil with a thickness of 10 μm, and was dried, followed by roll pressing, thereby manufacturing a negative electrode sheet.

Further, two separator sheets in each of which a ceramic particle layer (HRL) with a thickness of 4 μm was formed on a porous polyolefine layer of a three-layered structure of PP/PE/PP with a thickness of 20 μm were prepared.

The manufactured positive electrode sheet and negative electrode sheet, and the prepared two separator sheets were stacked one on another, and were wound, thereby manufacturing a wound electrode body. At this step, the HRL of the separator sheet was allowed to face the positive electrode sheet. Electrode terminals were attached to the positive electrode sheet and the negative electrode sheet of the manufactured wound electrode body, respectively, by welding, which was accommodated in a battery case having an injection port.

Subsequently, a nonaqueous electrolyte was introduced from the injection port of the battery case, and the injection port was hermetically sealed by a sealing screw. It should be noted that for the nonaqueous electrolyte, the one obtained by dissolving LiPF₆ as a support salt in a mixed solvent including ethylene carbonate (EC), dimethyl carbonate (DMC), and ethyl methyl carbonate (EMC) at volume ratios of 3:3:4 to a concentration of 1.0 mol/L was used. The resultant was allowed to stand for a prescribed time, so that the wound electrode body was impregnated with the nonaqueous electrolyte. Subsequently, this was subjected to initial charging, and was subjected to an aging treatment at 60° C., thereby obtaining an evaluating lithium ion secondary battery.

### Low Temperature Resistance Evaluation

Each activated evaluating lithium ion secondary battery was adjusted to SOC of 60%, and then, was placed under −10° C. environment. The each evaluating lithium ion secondary battery was subjected to charging at a current value of 15 C for 2 seconds. The voltage change amount ΔV at this step was acquired, and the battery resistance was calculated using the current value and ΔV. The ratio of the resistance of the evaluating lithium ion secondary battery using each coated graphite type negative electrode active material of other Comparative Examples and Examples with respect to the resistance of the evaluating lithium ion secondary battery using the coated graphite type negative electrode active material of Comparative Example 1 set as 100 was determined. The results are shown in Table 1.

TABLE 1

| | | Coating layer | Low |
|---|---|---|---|
| | Coating | lowermost part B | temperature |
| | configuration | content (atom %) | resistance ratio |
| Comparative | Monolayered carbon | 0 | 100 |
| Example 1 | layer | | |
| Comparative | Monolayered carbon | 0 | 110 |
| Example 2 | layer (burning | | |
| | treatment) | | |
| Example 1 | B-doped caron layer + | 0.3 | 95 |
| | carbon layer | | |
| Example 2 | B-doped caron layer + | 1.8 | 94 |
| | carbon layer | | |
| Example 3 | B-doped caron layer + | 4.6 | 96 |
| | carbon layer | | |
| Comparative | Monolayered B- | 2.3 | 103 |
| Example 3 | doped caron layer | | |

For Examples 1 to 3 each including a boron-doped intermediate layer provided therein, the low temperature resistance was smaller as compared with Comparative Example 1. This can be considered due to the fact that the boron-doped intermediate layer played a role of a buffer layer for relaxing the difference in crystallinity between graphite and the amorphous carbon layer, and improved the ion diffusibility between graphite and the amorphous carbon layer. In contrast, in Comparative Example 2, although burning was performed for the purpose of improving the crystallinity of the coating layer, the low temperature resistance increased as compared with Comparative Example 1. This can be considered due to the following fact: the whole coated graphite type negative electrode active material was heated, resulting in a decrease in difference in the crystallinity; however, the increase in resistance due to the increase in crystallinity of the carbon layer, which is the outermost layer, was larger than the decrease in resistance due to the reduction of the difference in crystallinity. Further, in Comparative Example 3, the coating layer was doped with boron. However, it is indicated that only doping of the coating layer with boron cannot produce the low temperature resistance reducing effect.

The description up to this point indicates as follows. With the coated graphite type negative electrode active material herein disclosed, it is possible to reduce the low temperature resistance of the secondary battery.

Up to this point, specific examples of the present disclosure were described in details. However, these are merely illustrative, and should not be construed as limiting the scope of the appended claims. The technology described in the appended claims includes various modifications and changes of the specific examples exemplified up to this point.

What is claimed is:

1. A coated graphite type negative electrode active material, comprising:
graphite;
an amorphous carbon layer coating the graphite; and
an intermediate layer situated between the graphite and the amorphous carbon layer, wherein
the intermediate layer is a carbon layer doped with boron, and
the amorphous carbon layer substantially does not include boron.

2. The coated graphite type negative electrode active material according to claim 1, wherein a dope amount of boron in the intermediate layer is 0.1 atom % or more and 5.5 atom % or less.

3. A method for manufacturing a coated graphite type negative electrode active material, the method comprising the steps of:
forming a first coating layer including carbon and boron on graphite by a chemical vapor deposition method using a gas including a carbon precursor and a boron precursor; and
forming a second coating layer including carbon on the first coating layer by a chemical vapor deposition method using a gas not including a boron precursor and including a carbon precursor.

4. A secondary battery comprising a positive electrode, a negative electrode, and an electrolyte, wherein the negative electrode includes the coated graphite type negative electrode active material according to claim 1.

5. A secondary battery comprising a positive electrode, a negative electrode, and an electrolyte, wherein the negative electrode includes the coated graphite type negative electrode active material according to claim 2.
